(19) United States
(12) Patent Application Publication
(10) Pub. No.: US 2011/0010867 A1
(43) Pub. Date: Jan. 20, 2011

(54) SPECIALIZED COMPRESSING AND OPENING TOOL FOR CHARM BRACELET

(76) Inventor: Dolores A. Bihl-Luark, Waterford, MI (US)

Correspondence Address: CARGILL & ASSOCIATES, P.L.L.C., 56 MACOMB PLACE, MT. CLEMENS, MI, 48043, US

(21) Appl. No.: 12/837,231

(22) Filed: Jul. 15, 2010

Related U.S. Application Data
(60) Provisional application No. 61/225,583, filed on Jul. 15, 2009.

(51) Int. Cl. B25B 7/22

(52) U.S. Cl. 7/125

(57) ABSTRACT

Charm bracelets utilizing new dimensions have specialized clasps that are difficult to open and close without ruining a woman's manicure, at best, and are difficult to manage with arthritis or any other physical impediment. Disclosed is a specialized compressing and opening tool for charm bracelets including a pair of handles distal from a crimper head, a crimper head having a set of nipper teeth for adjustably and releasably securing and closing a charm bracelet barrel clasp, wherein the nipper teeth define an opening to receive said barrel clasp, and a pry end opening tool integral with and manufactured from the compressing and opening tool. With this tool, the barrel clasp of the charm bracelet can be opened easily by the pry end opening tool, the charms can be added, subtracted, or rearranged, and then the crimper head of the tool can be used to close the clasp to re-secure the clasp about the bracelet, thereby securing the charms onto the bracelet in a positive and secure manner.

### CROSS REFERENCES TO RELATED APPLICATIONS

This application claims the benefit under 35 U.S.C. 119(e) of U.S. Provisional Application No. 61/225,583 filed on Jul. 15, 2010.

### TECHNICAL FIELD

This patent application relates to a specialized crimping and opening tool, and more particularly relates to a crimping and opening tool specific for charms and barrel clasps of PANDORA®, or PANDORA® -style bracelets.

### BACKGROUND OF THE INVENTION

Jewelry has long been a mainstay for women to adorn their bodies. In certain cases, various pieces of jewelry are meant to cause the recall of various memories, and it has become common practice to gift women with jewelry that reminds them of various birthdays of their children, accomplishments, anniversaries, and the like. In that regard, charm bracelets and picture lockets have long been conventional gifts for mothers and grandmothers, which is especially useful for Mothers Day, birthdays, and Christmas presents. As one can imagine, it is very difficult to find appropriate gifts that do not take up too much space. Charm bracelets are perfect for this purpose, because the charms are small, valuable, and do not need to be sized or fitted for any particular woman.

Recently, Pandora Jewelry, LLC, LTD, Liability Company of Columbia, Maryland began to produce bracelets that are becoming extremely popular. The PANDORA® bracelets, a registered trademark of Pandora Jewelry, LLC LTD, cited above, are used to hold little charms, not unlike the charm bracelets that were popular in the 40′s and 50′s. However, the PANDORA® jewelry has a particular type of charm, and the charm is adapted to be received upon a chain type of bracelet that has a particular configuration.

A problem has arisen because PANDORA® jewelry requires that the base bracelet needs to be fully opened to insert new charms. However, the base bracelet includes a barrel clasp which is difficult to open. The barrel clasp is received over the two terminal ends of the PANDORA® chain bracelet having detention knobs on either end, which once received within the barrel clasp, do not come undone. The barrel clasp is of a very unique design, and is rather difficult to open and close with a woman's fingernail, which is the suggested method. The clasp is difficult to open, which is a good thing when one considers the rather substantial investment that is made for the individual charms. Some charms cost as little at $16.00 US, while other charms made of gold can cost more than $500 US for just one charm. If the clasp came undone, and the charms were lost, a great monetary loss would be realized. Further, it is most important that a proper amount of pressure can be applied to make sure the clasp is firmly and securely closed after a charm has been added. To date, no such tool has appeared on the market.

The function of the bracelet is for charms to be added on as a woman is able to afford them, or as she might receive the charms as gifts. Opening and closing the barrel clasp that secures the two ends of the bracelet has become problematic.

It has been recommended by manufacturers of PANDORA®—style bracelets to open the barrel clasp in a way that requires the customer to insert the edge of a fingernail into the opening, apply pressure, and pry it open. Regarding this technique, various problems have arisen. For example, many women find it difficult to fit their fingernail into the small opening on the barrel clasp, especially if they use acrylic appliqués, which would increase the thickness of the nail. For women who keep their fingernails manicured and painted, the technique of applying pressure and prying the barrel clasp of the PANDORA®—style bracelet results in scraping, scratching and chipping of the manicure. Yet another problem associated with the aforementioned opening technique relates to the amount of pressure needed to pry open the barrel clasp. Women with arthritis in their hands may find it especially painful and difficult to apply a large amount of pressure, or at the angle necessary to open it, as the strength and agility of many joints in the hand are adversely affected by arthritis.

In the PANDORA® jewelry stream of commerce, there are millions of charms being sold every year, and each time a charm is put onto a bracelet, the barrel clasp, that is used to identify and signify the fact that the bracelet is an authentic PANDORA® piece of jewelry, must be opened. The charm is strung onto the chain bracelet and then the barrel clasp must be re-secured.

Otherwise, in order to open the barrel clasp, a jeweler is employed in order to open the clasp and slide the charm onto the chain bracelet. Certain customers have found this to be an unnecessary expense, and would like to be able to purchase a tool in order to open the barrel clasp, thereby allowing them to put the charm onto the bracelet, and then be able to re-close the barrel clasp in order to secure the bracelet.

Therefore, it would be desirable to have an invention which includes, as one or more of its aspects, a specialized jewelry tool that has the ability to easily open and securely close the barrel clasp easily on PANDORA® jewelry.

### SUMMARY OF THE INVENTION

In accordance with the desires of customers and the industry, disclosed is a specialized compressing, or crimping, and opening tool useful for unlocking a barrel clasp for a bracelet having a chain bracelet adapted for receiving multiple charms and collections of charms that may be collected over a long period of time.

The barrel clasp is used to secure the two ends of a PANDORA®—style bracelet after a charm has been strung thereon. The barrel clasp is difficult to open because the design is such that it won't open without work being done to it. For example, it would be most disadvantageous for the barrel clasp to come undone on its own, without the use of a tool, because, due to the nature of the PANDORA®—style bracelet, all of the charms would slide off of the ends of the unsecured PANDORA®—style bracelet.

In the crimping and opening tool made in accordance with the present invention, the opening tool is configured into one of the gripping handles of a crimping tool, where the crimper is at the works end of the tool, and the opening tool is at the distal end.

In operation, the distal end with a pointed, chiseled-like design, is utilized to pry open the barrel clasp. After the barrel clasp has been pried open, it falls away from the bracelet easily, thereby allowing a charm to be strung onto the bracelet. Thereafter, the barrel clasp is reattached between the two ends of the PANDORA®—style bracelet, and it crimped by the crimping tool end of the tool itself. The crimping tool area is dimensioned, sized and adapted to receive the barrel clasp therein, along with a multitude of charms that can also be crimped onto the bracelet. This tool is a multipurpose tool, and may be sued not only for barrel clasps, but may also be used for the various charms that are available for purchase.

The multi-purpose crimping and opening tool of the present invention will find great utility in jewelry stores, as well as jewelry boxes of PANDORA®-style bracelet charm customers. Such a tool will alleviate the need to be driving to a jeweler every time a customer wishes to reconfigure the orientation of the charms on her charm bracelet.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein:

FIG. 1 is a top plan view of the crimping and opening tool made in accordance with the present invention;

FIG. 2 is a top plan view of a PANDORA®—style bracelet having multiple charms on a chain bracelet;

FIG. 3A is an exploded view of the opening portion of the crimping and opening tool;

FIG. 3B illustrates yet another view of the opening tool;

FIG. 4 is a view of the opening tool entering the barrel clasp;

FIG. 5 is a view of the opening tool after it has opened the barrel clasp;

FIG. 6 shows the crimping portion of the tool of the present invention being placed in a location to close the barrel clasp;

FIG. 7 shows the midway point of the crimping tool closing the barrel clasp; and

FIG. 8 illustrates the crimping tool in its final stages of closing the barrel clasp.

### DETAILED DESCRIPTION OF THE INVENTION

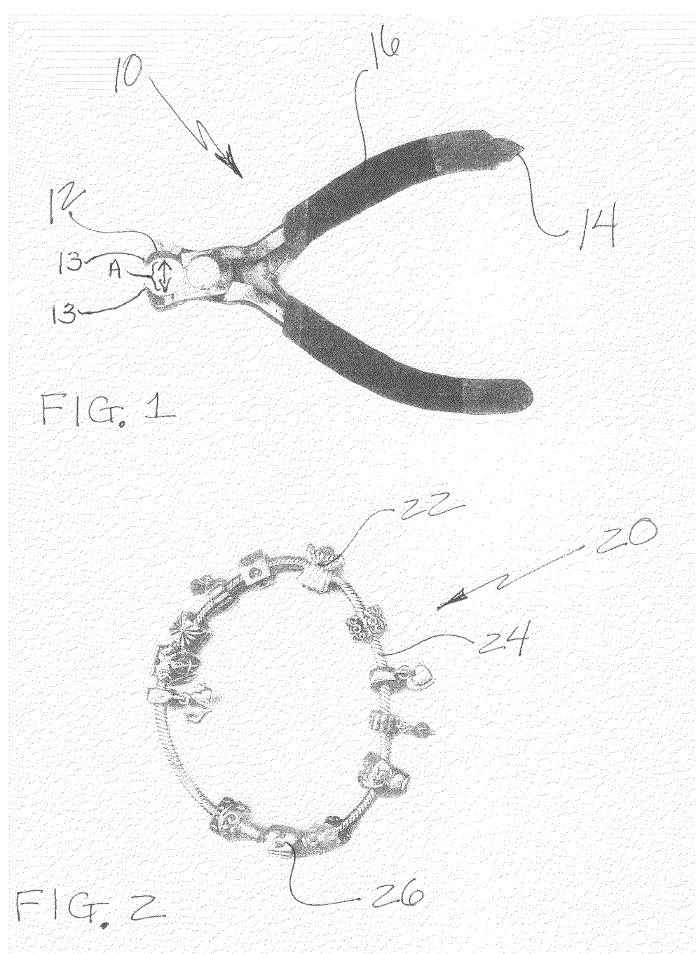

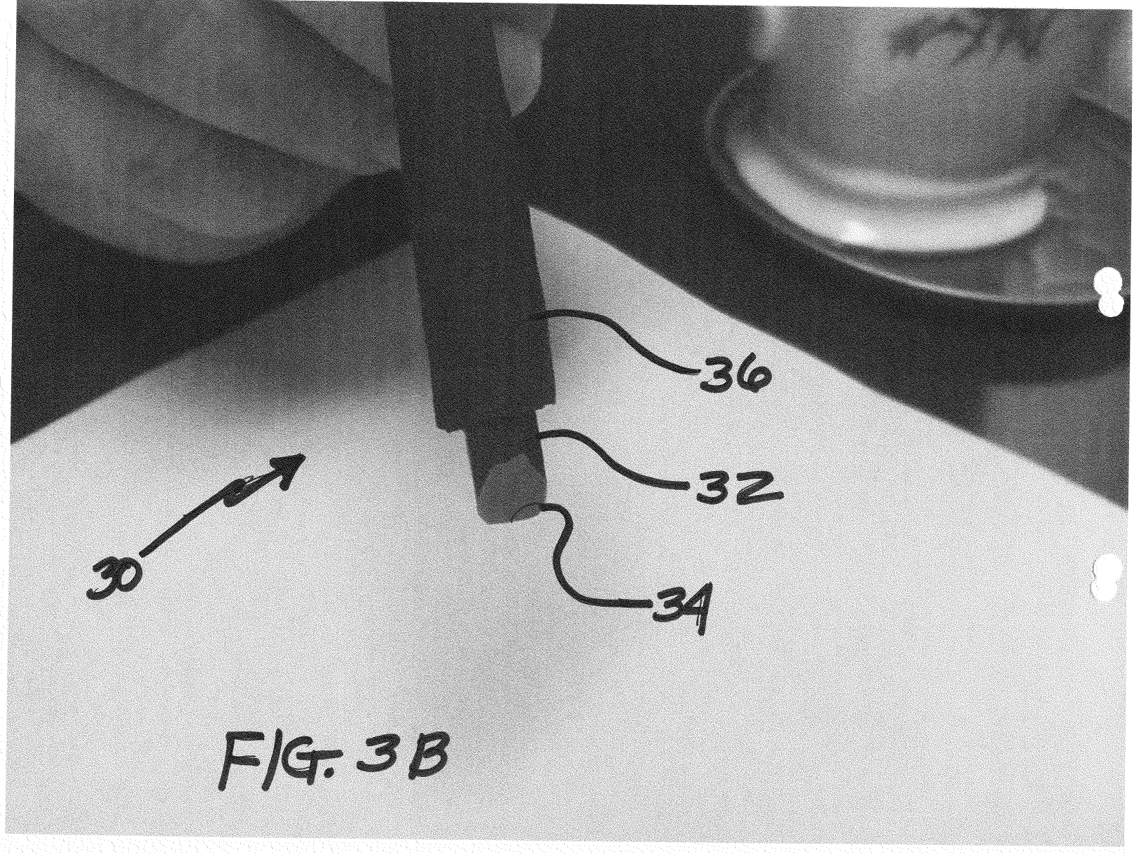

FIG. 1 shows a new jewelry tool made in accordance with the present invention. There is disclosed a new and specialized crimping and opening tool, generally denoted by the numeral 10, including a crimping head 12 having a special diameter “A” between its nipper teeth 13 along with an opening tool 14 at the end of one of the handles 16. These crimping and opening tool features are used sequentially to easily open and re-close a barrel clasp on a PANDORA® or a PANDORA®—style charm bracelet. First, the opening tool 14 is used to pry open the barrel clasp, as is more fully described herein below with reference to FIGS. 3A through 5. After the clasp is opened, a charm can be inserted onto the chain itself, and then the clasp can be reattached to the bracelet by using the crimping head 12 of the crimping and opening tool 10. Diameter “A” is the substantially circular interior diameter of the present tool and it is suitable and adapted for surrounding and receiving one of the barrel clasps. The tool is especially useful for opening and closing barrel clasps and charms that are commercially available from PANDORA® Jewelry Company of Columbia, Md. Diameter “A” may be any suitable size. However, PANDORA® and PANDORA®—style barrel clasps and charms are fairly uniform in size. Therefore, Diameter “A” has a dimension of from 0.2 mm to over 2.00 mm. Although classic PANDORA® barrel clasps are about 1.0 mm in diameter, Diameter

“A” may be adjustable from 0.2 mm up to 2.0 mm to accommodate a wide array of styles and sizes. For best fit, Diameter “A” may be a 1.0 mm opening when nipper teeth 13 touch one another, nipper teeth 13 curve around and are adapted and sized to receive various clasps, as well as a full array of charms.

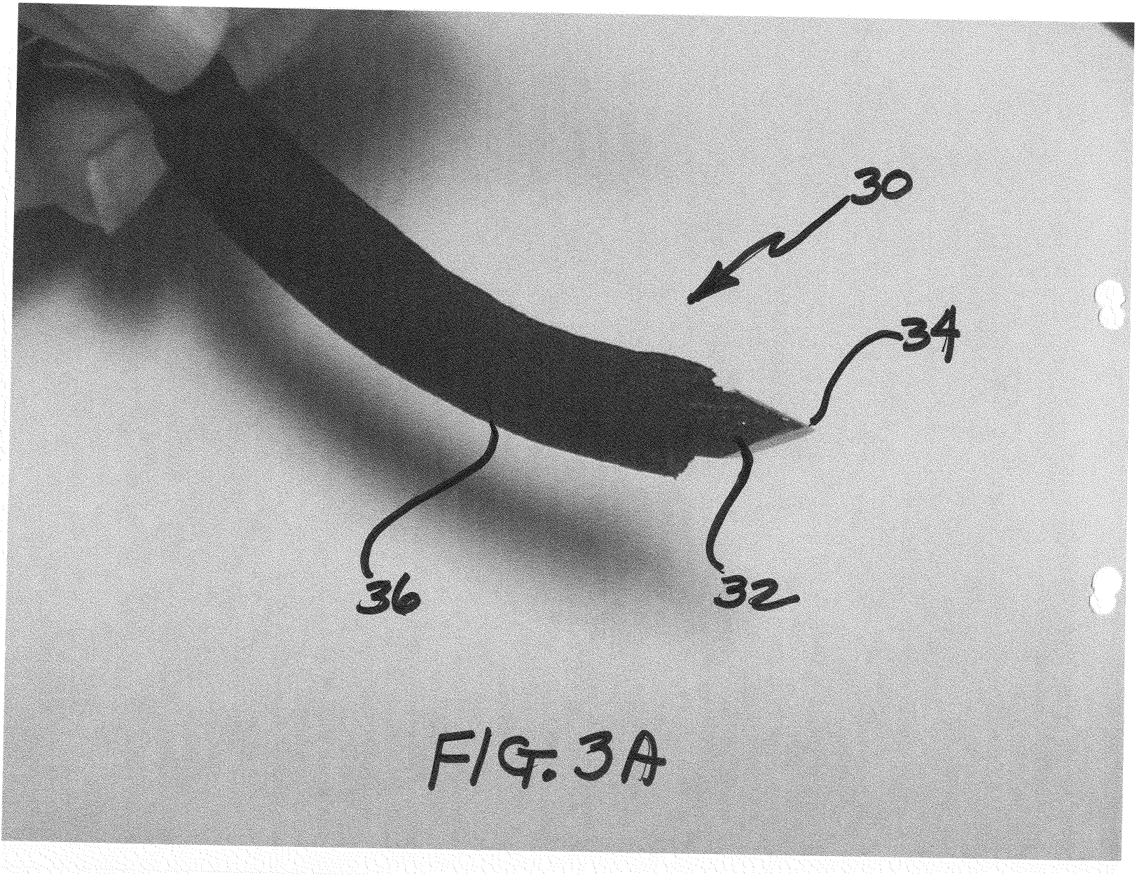

FIG. 2 is a top plan view of a typical PANDORA® or PANDORA®—-style bracelet 20 has charms 22 threaded over the chain bracelet 24. Barrel clasp 26 secures the ends of chain bracelet 24 after the charms have been put thereon. In the past, barrel clasp 26 has been so difficult to open and close, that many of the purchasers of the PANDORA® or PANDORA®—style charm bracelet take their purchases to a jeweler where he opens the barrel clasp, inserts the charm purchased at his establishment, and then recloses the barrel clasp. Most women tried to use tools that were not meant for the task, as they did not combine the appropriate tools together in one crimping and opening tool.

Looking now to FIG. 3A, the opening end of the tool shown in FIG. 1 is generally denoted by numeral 30, including an opening end tool 32 having a pry end 34 extending out of the handle 36. FIG. 3B is another view of the same end of the tool 30, showing in more detail the opening tool and 32 having a flat head pointed end 34 extending out of the handle 36. Furthermore, the pointed end prying tool can be located anywhere on the handles of the crimping head of the tool of the present invention. For example, pointed end 14 could come off the top of the nipper teeth 13, instead of on the handle. It appears to be slightly more advantageous to have it come in off of one of the handles, as shown in FIG. 1. The angle of the pointed end of the prying tool 14 may be from an essentially flat thin plate dimension with a angular expansion of from about 3 degrees to about 55 degrees in order to enable the opening of a barrel clasp. The pry end may be made out of metal, plastic, wood, ceramic, or any other suitable material. When using the prying tool on gold or sterling silver charms, it may be more advantageous to utilize a plastic or wooden material, so as not to scratch the metal on the clasp. In addition, pry end 14 may be made of a metal dipped in plastic, or a plastic with a ceramic, or tungsten carbide, coating thereon. The face of the pried point 32 may include a flat head pointed end 34 that terminates in a pointed end 34 having a sufficiently thin dimension of angular circumference so that it is adapted for and suitable to open a barrel clasp of the PANDORA® or PANDORA®—style bracelet.

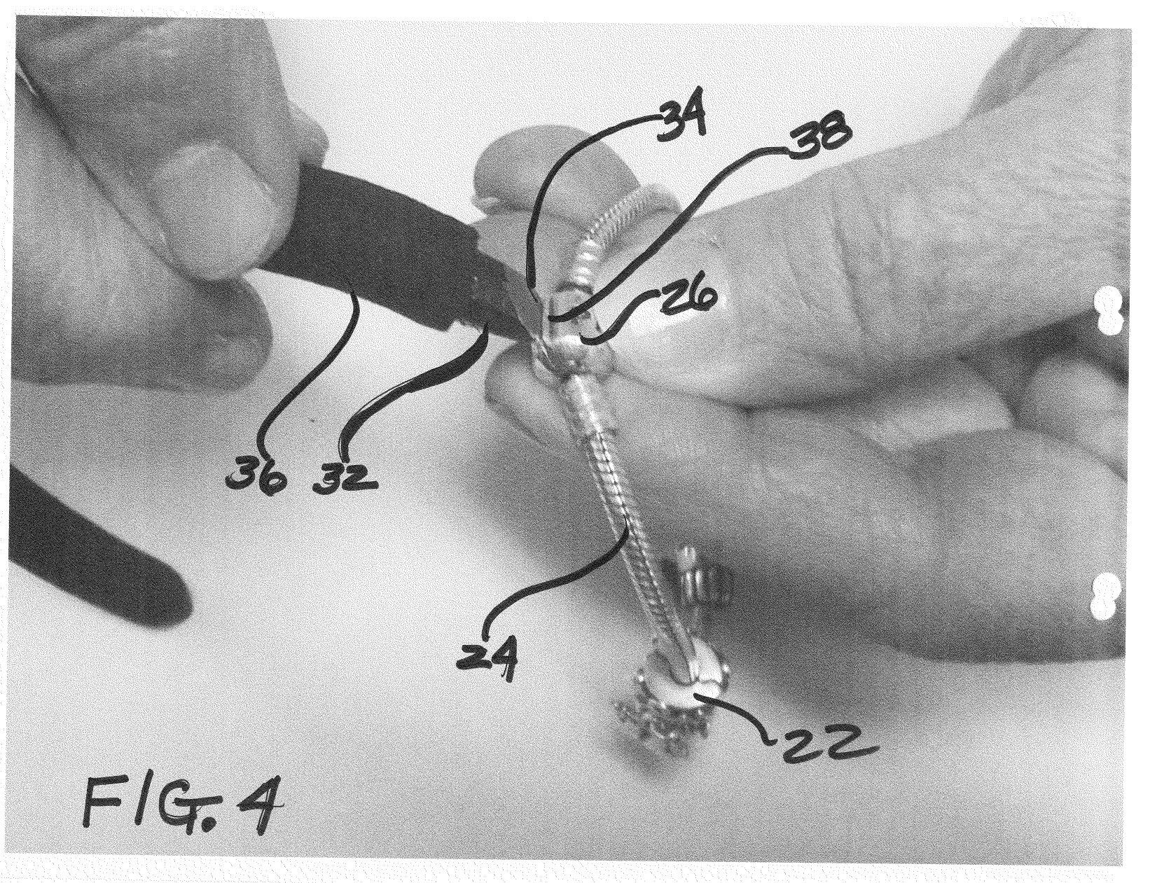

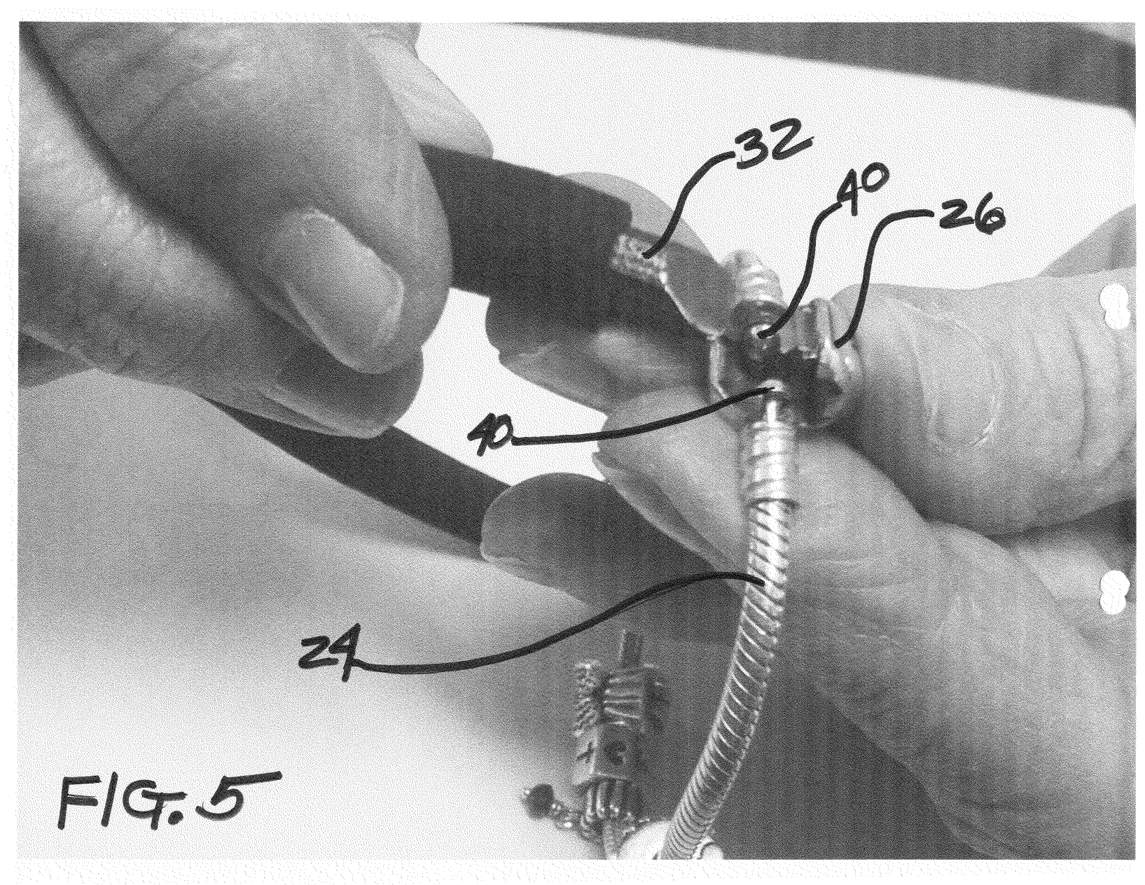

FIGS. 4 and 5 make combined reference to sequential element numbers in showing the progression of utilizing the opening tool 32. Pointed end 34 extending from handle 36 is inserted into slot 38 of the barrel clasp 26 securing the ends of chain bracelet 24. FIG. 5 shows the barrel clasp in its open configuration. Once open, the barrel clasp 26 reveals the knob ends 40 which terminate the chain bracelet 24. Knob ends 40 catch within barrel clasp 26 after it is closed back together.

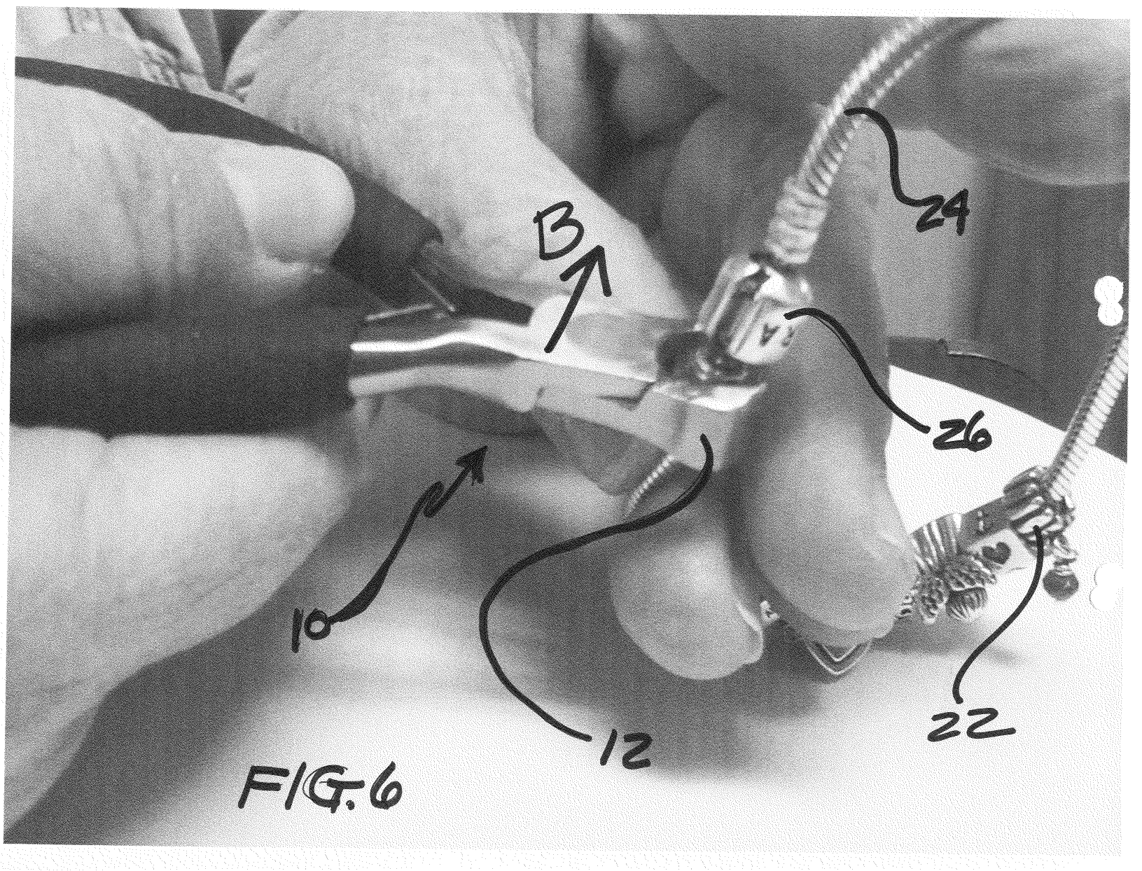

Looking next to FIG. 6, once the charm 22 has been inserted over chain bracelet 24 and aligned to catch both knob ends (not seen in this view), barrel clasp 26 must be reattached in order to secure the knob ends 40 of charm bracelet 24. Crimping tool 10 includes a crimping end 12 shown here as being threaded over barrel clasp in direction “B”.

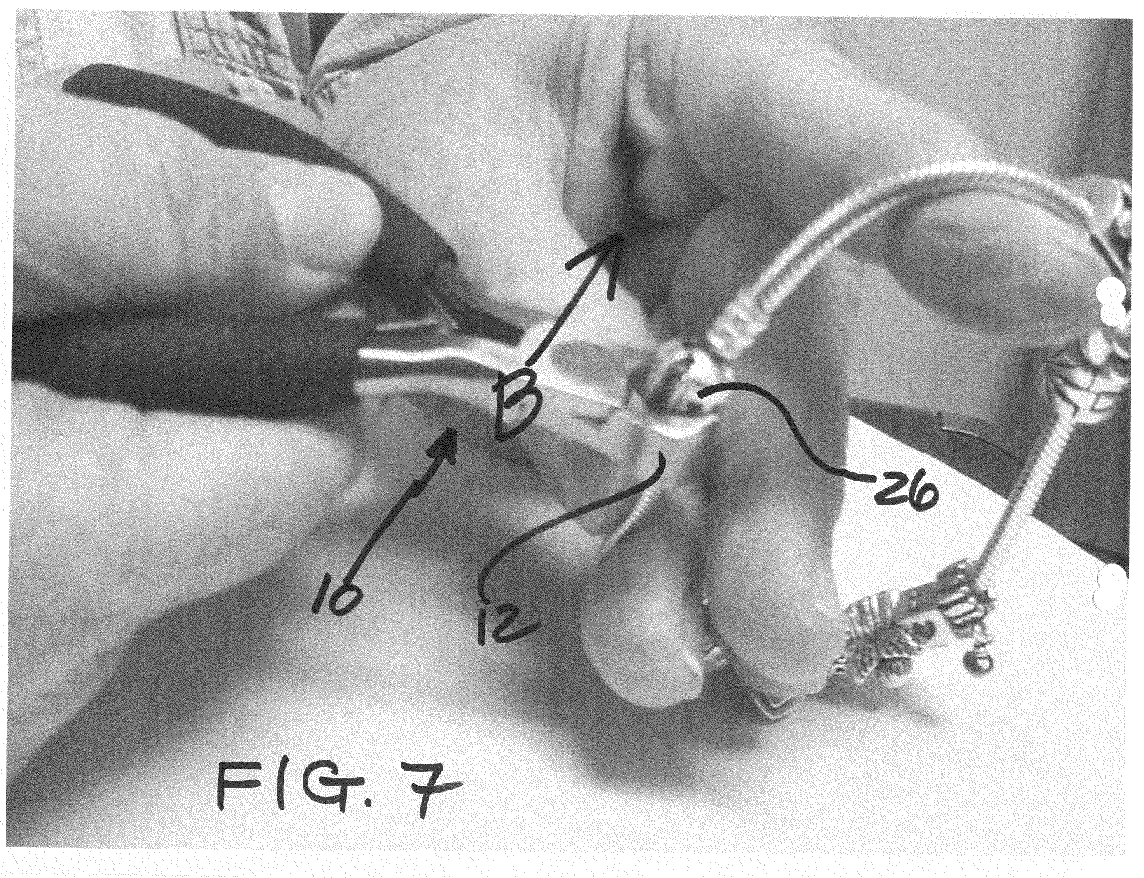

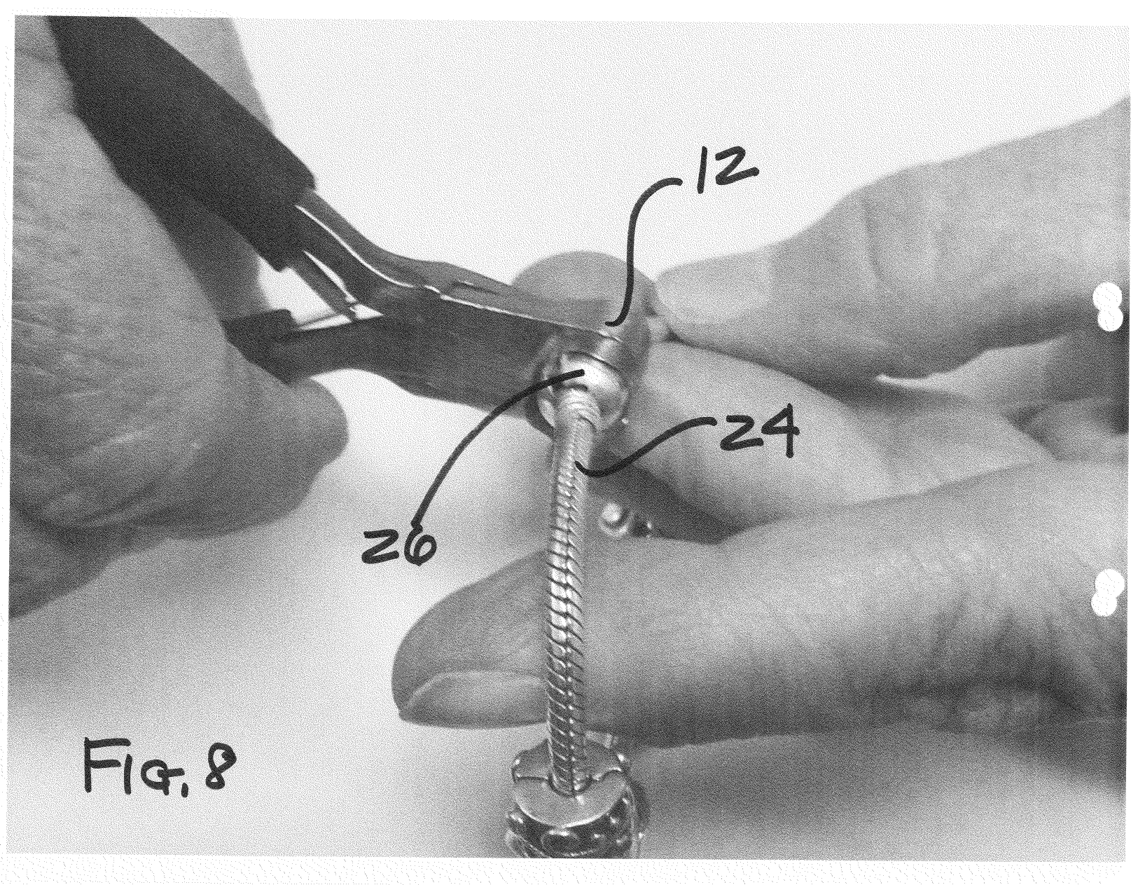

Referring next to FIG. 7, the crimping tool 10 is illustrated in a further progression in the direction “B”, covering the barrel clasp 26, while FIG. 8 illustrates the final position of the crimping tool end 12 over barrel clasp 26 securing the two ends of charm bracelet 24. The pry end may be made out of metal, plastic, wood, ceramic, or any other suitable material. When using the prying tool on gold or sterling silver charms, it may be more advantageous to utilize a plastic or wooden material, so as not to scratch the metal on the clasp.

In addition, pry end 14 may be made of a metal dipped in plastic, or a plastic with a ceramic, or tungsten carbide, coating thereon.

Therefore, there is disclosed an invention that can be uniquely utilized for easily opening and closing barrel clasp of a PANDORA® bracelet or a PANDORA®—style bracelet while saving a woman's manicure.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto.

1. A specialized compressing and opening tool for charm bracelets, comprising:
A pair of handles distal from a crimper head;
A crimper head having a set of nipper teeth for adjustably and releasably securing and closing a charm bracelet barrel clasp, wherein the nipper teeth define an opening to receive said barrel clasp; and
A pry end opening tool integral with and manufactured from the compressing and opening tool, Whereby the barrel clasp of the charm bracelet can be opened easily by the pry end opening tool, the charms can be added, subtracted, or rearranged, and then the crimper head of the tool can be used to close the clasp to re-secure the clasp about the bracelet, thereby securing the charms onto the bracelet in a positive and secure manner.

2. The specialized compressing and opening tool for charm bracelets of claim 1, wherein the tool may be made from a material selected from the group consisting of metal, plastic, wood, ceramic and combinations thereof.

3. The specialized compressing and opening tool for charm bracelets of claim 1, wherein the pry end opening tool may be located anywhere on the tool.

4. The specialized compressing and opening tool for charm bracelets of claim 1, wherein the pry end opening tool is located on the distal end of one of the handles distal from the crimper head.

5. The specialized compressing and opening tool for charm bracelets of claim 1, wherein the pry end opening tool may be a flat portion of one of the nipper teeth located at the top of the crimper head.

6. The specialized compressing and opening tool for charm bracelets of claim 1, wherein the pry end opening tool has an angular dimension of from 3° to about 55°.

7. The specialized compressing and opening tool for charm bracelets of claim 1, wherein the opening in the nipper teeth includes an interior diameter of from 0.2 mm to 2.0 mm.
